(19) United States
(12) Patent Application Publication
(10) Pub. No.: US 2018/0006951 A1
(43) Pub. Date: Jan. 4, 2018

(54) Hybrid Computing Resources Fabric Load Balancer

(71) Applicant: INTEL CORPORATION, Santa Clara, CA (US)

(72) Inventors: Francesc Guim Bernat, Barcelona (ES); Karthik Kumar, Candler, AZ (US); Thomas Willhalm, Sandhausen (DE); Raj K. Ramanujan, Federal Way, WA (US); Daniel Rivas Barragan, Cologne (DE)

(73) Assignee: INTEL CORPORATION, Santa Clara, CA (US)

(21) Appl. No.: 15/201,394

(22) Filed: Jul. 2, 2016

(51) Int. Cl. H04L 12/803; H04L 29/08; H04L 12/26

(52) U.S. Cl. CPC H04L 47/125; H04L 43/08; H04L 67/1023

(57) ABSTRACT

Examples may include techniques to distribute queries in a fabric of nodes configured to process the queries. A load balancing switch coupled to the nodes can receive indications of resource metrics from the nodes and can schedule and distribute the queries based on the resource metrics and network metrics identified by the switch. The switch can include programmable circuitry to receive selected resource metrics and identify selected network metrics and to distribute queries to nodes based on the metrics and distribution logic.

### TECHNICAL FIELD

Examples described herein are generally related to configurable computing resources and particularly to managing the sharing of such configurable computing resources.

### BACKGROUND

Computing tasks involving analyzing large datasets can be facilitated by multiple servers concurrently processing the computing task. Often, the computing task involves multiple computing tasks, which may be data parallel. Said differently, multiple servers can concurrently operate on subsets of the total dataset, and thus proceed in parallel.

The multiple servers are often controlled by a fabric manager, which can schedule each of the multiple servers to perform the computing tasks. An issue with such systems in the overall efficiency of the system. More specifically, the system as a whole needs to be efficient in distributing work between the various servers. Efficiently operating such a system requires distributing work based on a number of computing metrics, all of which effect the efficiency of the overall system.

### BRIEF DESCRIPTION OF THE DRAWINGS

FIG. 1 illustrates an example first system.

FIG. 2 illustrates a first example query processing system.

FIG. 3 illustrates a second example query processing system.

FIG. 4 illustrates a third example query processing system.

FIG. 5 illustrates an example information element.

FIG. 6 illustrates a first example logic flow.

FIG. 7 illustrates a second example logic flow.

FIG. 8 illustrates a third example logic flow.

FIG. 9 illustrates an example of a storage medium.

FIG. 10 illustrates an example computing platform.

### DETAILED DESCRIPTION

In general, the present disclosure provides a switch to manage scheduling and allocation of various computing tasks across a fabric of computing resources. More specifically, a fabric switch and techniques to be implemented by a fabric switch are disclosed. The fabric switch and associated techniques can schedule and load balance computing tasks across nodes of a fabric of computing resources. The computing tasks can corresponds to multiple computing task operating on subsets of a dataset. In some examples, the fabric switch can include an field programmable gate array (FPGA) to configure the fabric switch based on various registration protocols, service level agreements, or the like.

The fabric switch includes an interface, such as, an application programming interface (API), to receive information including indications of the load of nodes in the fabric. For example, the switch can be coupled to a host fabric interface (HFI) in each of the nodes in the fabric. The switch and the HFI can communicate messages to include indications of node load and also to include indications of scheduling tasks. The fabric switch can schedule and allocate computing tasks among the nodes based on the indications of node load in addition to various network metrics in which the fabric switch has visibility. For example, the fabric switch may have visibility into network congestion, network traffic, latency across the network, latency between nodes of the network, or the like. Furthermore, the fabric switch may identify when nodes are down and reschedule and/or revert load balancing decisions.

Accordingly, a fabric switch may act as a hybrid load balancer and query distributor in a distributed computing environment to scale large computing fabrics for big data and/or enterprise computing requirements. Implementing scheduling via a switch as disclosed provides that awareness of network metrics in conjunction with indications of node utilization or load can be used to make more adaptive and intelligent decisions regarding how (and who) to deliver messages. Furthermore, the hybrid scheduling coordinated between the switch and the HFI can be implemented in hardware to provide quicker scheduling decisions without offloading scheduling to a node in the fabric. Additionally, as the scheduling component within the switch can be implemented using an FPGA, configurability and/or segregation between multiple datasets can be achieved.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, known structures and devices are shown in block diagram form in order to facilitate a description thereof. The intention is to provide a thorough description such that all modifications, equivalents, and alternatives within the scope of the claims are sufficiently described.

Additionally, reference may be made to variables, such as, “a”, “b”, “c”, which are used to denote components where more than one component may be implemented. It is important to note, that there need not necessarily be multiple components and further, where multiple components are implemented, they need not be identical. Instead, use of variables to reference components in the figures is done for convenience and clarity of presentation.

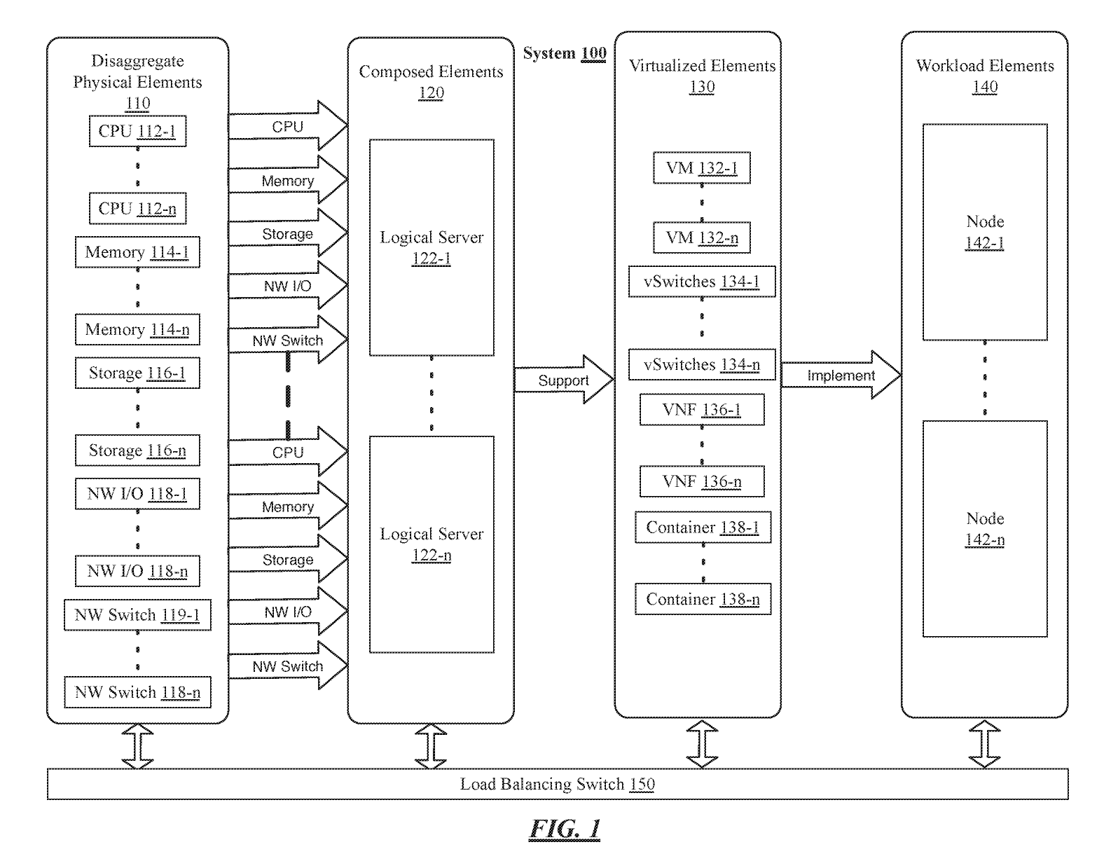

FIG. 1 illustrates an example first system 100. In some examples, system 100 includes disaggregate physical elements 110, composed elements 120, virtualized elements 130, workload elements 140, and load balancing switch 150. In some examples, the load balancing switch 150 may be arranged to manage or control at least some aspects of disaggregate physical elements 110, composed elements 120, virtualized elements 130 and workload elements 140. In general, the load balancing switch 150 provides for scheduling of computing tasks to the disaggregate physical elements 110, the composed elements 120, virtualized elements 130, and/or workload elements 140 based on the various metrics (e.g., resource utilization, latency, network throughput, or the like). For example, the load balancing switch 150 may be configured to receive a query request including an indication to process a query on a dataset, or a subset of a dataset. The load balancing switch 150 can distribute the query request to ones of the disaggregate physical elements 110, the composed elements 120, virtualized elements 130, and/or workload elements 140.

During operation, the load balancing switch 150 can receive metrics (e.g., resource utilization, telemetry counters, or the like) from the disaggregate physical elements 110, the composed elements 120, virtualized elements 130, and/or workload elements 140. Additionally, as the load balancing switch 150 acts as a network switch within the system 100, the load balancing switch 150 can have visibility to various network metrics (e.g., latency, throughput, or the like). The load balancing switch 150 can distribute the query requests based on the received metrics and the network metrics.

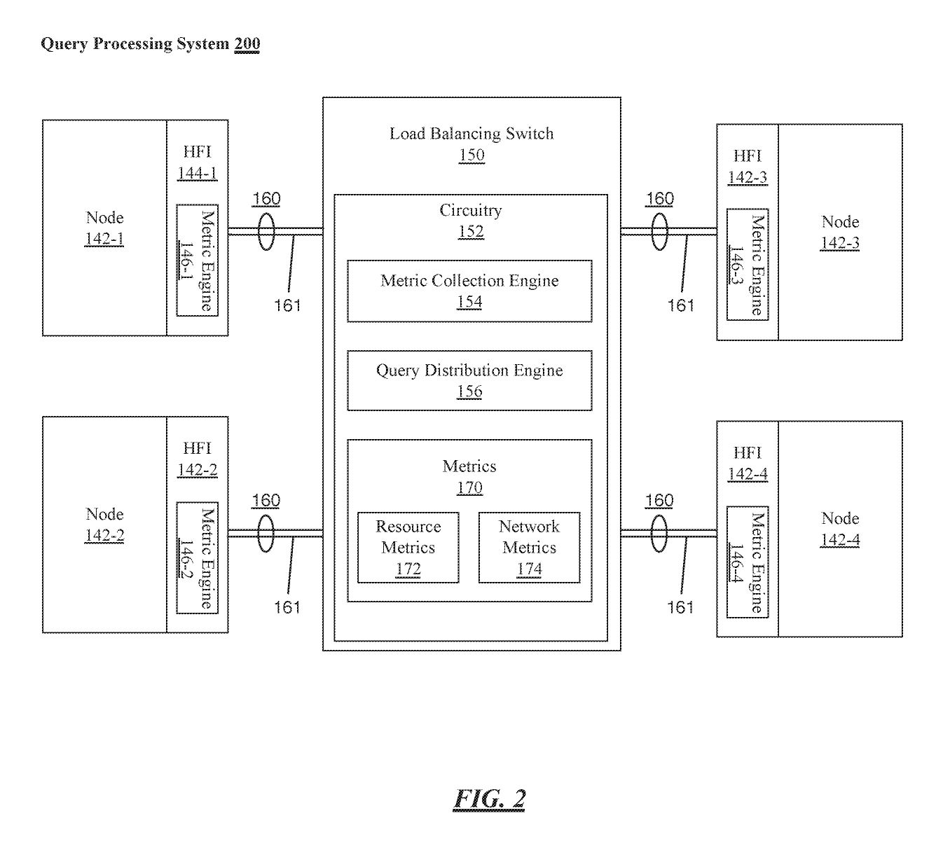

In some examples, the load balancing switch 150 can have a programmable (e.g., FPGA, or the like) query distribution engine (e.g., refer to FIG. 2). The programmable distribution engine can be programmed to distribute queries based on various policies (e.g., service level agreements, or the like).

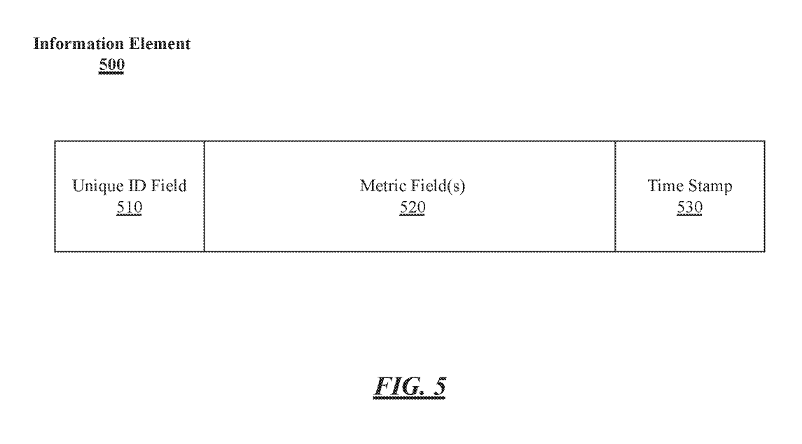

In some examples, the load balancing switch can receive indications of metrics, receive query requests, and distribute query requests based on a message protocol. An example message protocol is described below, for example, with reference to FIGS. 5-8.

According to some examples, as shown in FIG. 1, disaggregate physical elements 110 may include CPUs 112-1 to 112-n, where “n” is any positive integer greater than 1. CPUs 112-1 to 112-n may individually represent single microprocessors or may represent separate cores of a multi-core microprocessor. Disaggregate physical elements 110 may also include memory 114-1 to 114-n. Memory 114-1 to 114-n may represent various types of memory devices such as, but not limited to, dynamic random access memory (DRAM) devices that may be included in dual in-line memory modules (DIMMs) or other configurations. Disaggregate physical elements 110 may also include storage 116-1 to 116-n. Storage 116-1 to 116-n may represent various types of storage devices such as hard disk drives or solid state drives. Disaggregate physical elements 110 may also include network (NW) input/outputs (I/Os) 118-1 to 118-n. NW I/Os 118-1 to 118-n may include network interface cards (NICs) or host fabric interfaces (HFIs) having one or more NW ports w/associated media access control (MAC) functionality for network connections within system 100 or external to system 100. Disaggregate physical elements 110 may also include NW switches 119-1 to 119-n. NW switches 119-1 to 119-n may be capable of routing data via either internal or external network links for elements of system 100.

In some examples, as shown in FIG. 1, composed elements 120 may include logical servers 122-1 to 122-n. For these examples, groupings of CPU, memory, storage, NW I/O or NW switch elements from disaggregate physical elements 110 may be composed to form logical servers 122-1 to 122-n. Each logical server may include any number or combination of CPU, memory, storage, NW I/O or NW switch elements.

According to some examples, as shown in FIG. 1, virtualized elements 130 may include a number of virtual machines (VMs) 132-1 to 132-n, virtual switches (vSwitches) 134-1 to 134-n, virtual network functions (VNFs) 136-1 to 136-n, or containers 138-1 to 138-n. It is to be appreciated, that the virtual elements 130 can be configured to implement a variety of different functions and/or execute a variety of different applications. For example, the VMs 132-a can be any of a variety of virtual machines configured to operate or behave as a particular machine and may execute an individual operating system as part of the VM. The VNFs 136-a can be any of a variety of network functions, such as, packet inspection, intrusion detection, accelerators, or the like. The containers 138-a can be configured to execute or conduct a variety of applications or operations, such as, for example, email processing, web servicing, application processing, data processing, or the like.

In some examples, virtualized elements 130 may be arranged to form workload elements 140, also referred to as virtual servers. Workload elements can include any combination of ones of the virtualized elements 130, composed elements 140, or disaggregate physical elements 110. Workload elements can be organized into computing nodes, or nodes, 142-1 to 142-n.

The load balancing switch 150 can be configured to receive metrics from the disaggregate physical elements 110, the composed elements 120, the virtualized elements 130, and/or the workload elements 140. For example, the load balancing switch can receive a message to include an indication of a resource utilization of the nodes 142-1 and the node 142-n. The load balancing switch 150 can distribute a new query request to either the node 142-1 or the node 142-n based on the received metrics in addition to network metrics (e.g., latency, or the like) of the nodes 142-1 and 142-n.

It is noted, the load balancing switch 150 can distribute query requests to any computing element of the system 100. However, for purposes of clarity and brevity, the balance of the disclose discussed receiving metrics from and distribution of queries to the nodes 142. Examples however, are not limited in this context.

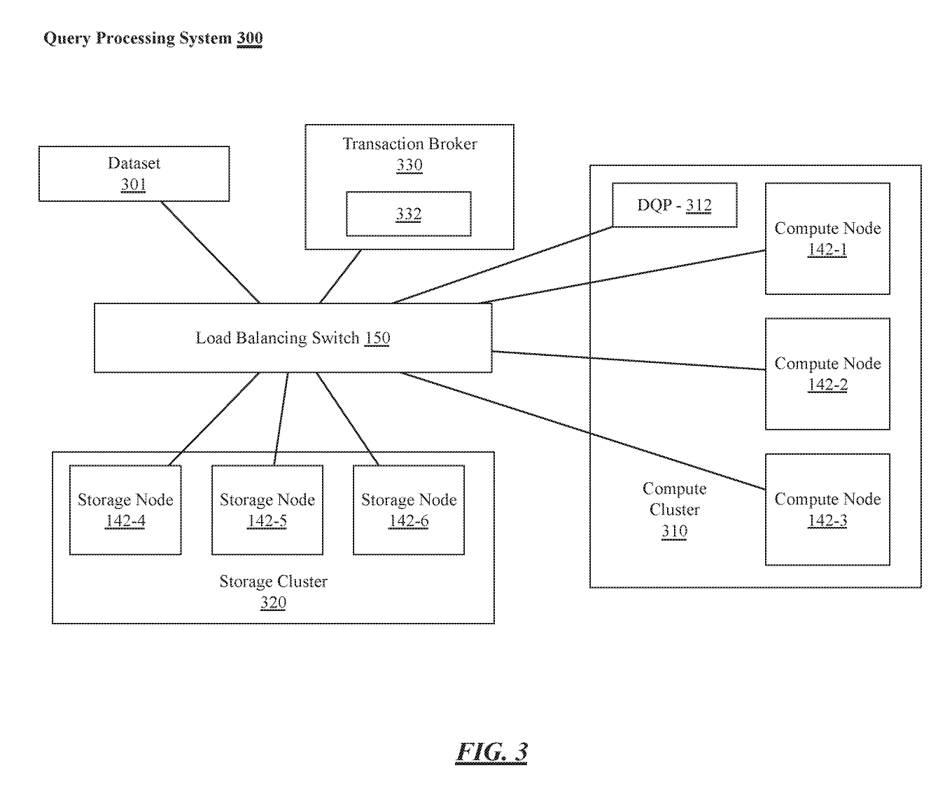

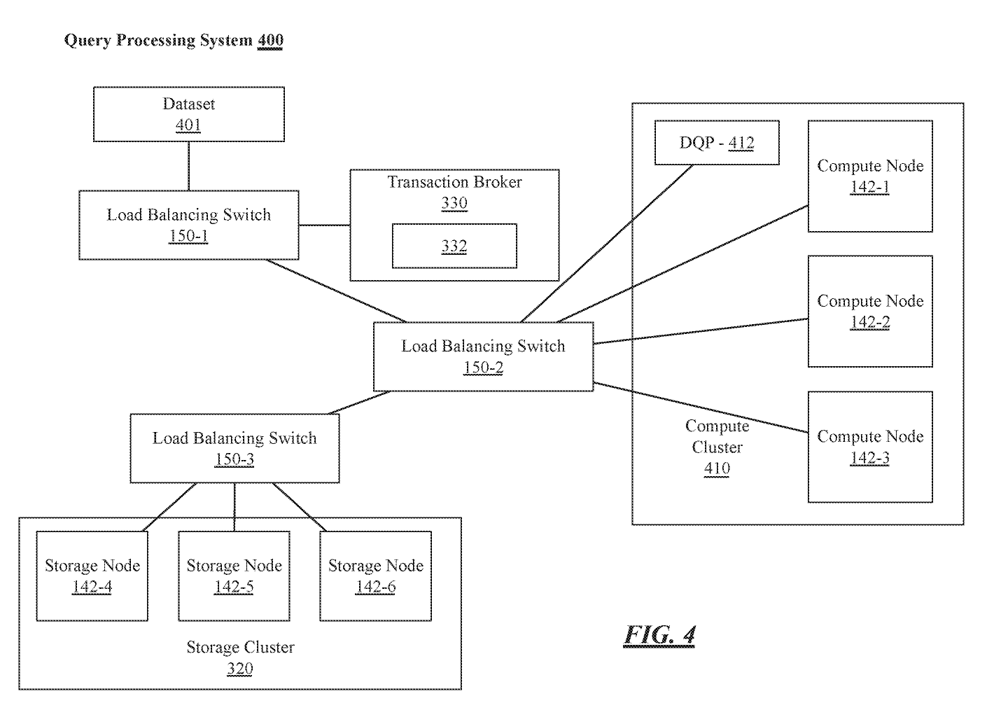

FIGS. 2-5 illustrate example query processing systems, arranged according to examples of the present disclosure. More specifically, FIG. 2 depicts a general query processing system 200 while FIGS. 3-4 depict example implementations of query processing systems 300 and 400, respectively. It is important to note, that depicted example systems 200, 300, and 400 are described with reference to portions of the example system 100 shown in FIG. 1. This is done for purposes of conciseness and clarity. However, the example systems 200, 300, and 400 can be implemented with different elements than those discussed above with respect to the system 100. As such, the reference to FIG. 1 is not to be limiting. Furthermore, it is important to note, that the present disclosure often uses the example of distributing a received query to a compute node. However, the systems described herein can be implemented to schedule and distribute multiple queries or optimize query distribution for a number of queries related to a dataset or subsets of a dataset. Examples are not limited in this context.

Turning more particularly to FIG. 2 and the query processing system 200. The system 200 can include nodes 142-a. In particular, nodes 142-1, 142-2, 142-3, and 142-4 are depicted. The nodes 142 can comprise any collection of computing elements (e.g., physical and/or virtual) arranged to process queries. Each of the nodes 142 can be coupled to the system, or fabric, through a host fabric interface (HFI) 144. For example, node 142-1 is coupled into the system 200 via HFI 144-1, node 142-2 is coupled into the system 200 via HFI 144-2, node 142-3 is coupled into the system 200 via HFI 144-3, and node 142-4 is coupled into the system 200 via HFI 144-4. HFIs 144 can couple their local nodes to the system 200 via network links 160 and load balancing switch 150. In general, the network links 160 can be any link, either physical or virtual, configured to allow network traffic (e.g., information elements, data packets, or the like) to be communicated. Thus, the nodes 142 are coupled to the system 200, thereby forming a fabric, via HFIs 144, network links 160, and load balancing switch 150.

Each of the HFIs 144 can include a metric engine 146. For example, HFI 144-1 includes metric engine 146-1, HFI 144-2 includes metric engine 146-2, HFI 144-3 includes metric engine 146-4, and HFI 144-4 includes metric engine 146-4.

The load balancing switch 150 can include circuitry 152, which can be programmable, to receive collected metrics, receive query requests, and distribute the query requests to nodes of the system 200. In some examples, the circuitry 152 can be an FPGA. It is noted, that the load balancing switch 150, and particularly, the circuitry 152 is described with reference to an FPGA. However, the logic 152 could be implemented using other programmable logic devices, such as, for example, complex programmable logic devices (CPLD), or the like.

The circuitry 152 can include a metric collection engine 154 and a query distribution engine 156. Furthermore, the circuitry 152 can include metrics 170. The metric collection engine 154 and the query distribution engine 156 can be implemented by functional blocks within the logic circuitry 152. Furthermore, the metrics 170 can be an information element or multiple information elements, including indications of metrics (e.g., metrics collected at nodes 142 and metrics identified and/or collected by the switch 150) related to the nodes 142 and the system 200.

In general, the metric engines 146 can collect metrics (e.g., resource utilization, pmon counter, telemetry counters, or the like) of the local node 142 and expose them to the load balancing switch 150. For example, the metric engine 146-1 can collect metrics including a CPU utilization rate of the node 142-1. Additionally, the metric engine 146-1 can send an information element including an indication of the collected metrics to the load balancing switch. For example, the metric engine 146-1 can send an indication of metrics related to node 142-1 to the switch 150 via the network links 160.

The metric collection engine 154 can receive the collected metrics from the metric engines 146. For example, the metric collection engine 154 can receive metrics collected by metric engine 146-1 via network link 160, and particularly virtual network channel 161. The received metrics can be stored (e.g., in a computer-readable memory storage location, which can be non-transitory) as metrics 170. In particular, the load balancing switch 150 can maintain resource metrics 172 and network metrics 174, where the resource metrics 172 include indications of metrics corresponding to the nodes 142 (e.g., as received from the HFIs 144, or the like) and network metrics 174 include indications of metrics corresponding to the network (e.g., to network links 160, or the like).

In some examples, the metric engines 146 can be programmable. Said differently, various operational parameters of the metric engines 146 can be set. For example, the metric engines 146 can be configured via configuration registers, such as, model-specific registers (MSRs), or the like. In particular, the metric engines can be configured to specific the metrics to be collected, a frequency of collection, a frequency of reporting metrics to the load balancing switch 150, or the like.

In some examples, the metric engine 146 can report metrics to the load balancing switch 150 via a virtual channel 161 of the network links 160. In particular, the metric engine

The metric collection engine 154 can receive metrics from HFIs 144, and in particular, from metric engines 146 and can collect metrics. In particular, the metric collection engine 154 can collect metrics related to network links 160. For example, the metric collection engine 154 can collect metrics such as, latency of the network links 160, throughput of the network links 160, or the like.

The query distribution engine 156 can receive a query request. In particular, the query distribution engine can receive a request including an indication to execute a query on a dataset or a subset of a dataset. The query distribution engine 156 can distribute the query to one of the nodes 142 based on the metrics 170. In particular, the query distribution engine 156 can distribute the query request based on the metrics received from each of the nodes 142 and the network metrics collected at the switch 150. It is important to note, that any distribution and/or load balancing algorithm or technique could be implemented to select which node to distribute the query request to. Examples are not limited in this context. However, it is important to note, the distribution technique can take into account both metrics collected at the local nodes and metrics visible to the switch, where the circuitry 152 resides.

The system 200 can be implemented for use with all types of data networks, I/O hardware adapters and chipsets, including follow-on chip designs which link together computing devices for data processing, such as, for example, distributed and/or parallel data processing on large datasets including a number of data subsets.

Turning more particularly to FIG. 3 and the query processing system 300. The system 300 can include a compute cluster 310, a storage cluster 320, a transaction broker 330, and a load balancing switch 150. The compute cluster 310 can include compute nodes, for example, nodes 142 configured to execute queries while the storage cluster 320 can include storage nodes, for example, nodes 142 configured to store data. In particular, the compute cluster 310 is depicted including compute nodes 142-1, 142-2, and 142-3 while the storage cluster 320 is depicted including storage nodes 142-4, 142-5, and 142-6. It is noted, the depicted nodes 142 can comprise any number or arrangement of elements, such as, elements depicted in FIG. 1. For example, compute nodes 142-1, 142-2 and 142-3 can include CPU 112 and memory 114 elements while storage nodes 142-4, 142-5, and 142-6 can include at least storage elements 116. Examples are not limited in this context.

In general, the load balancing switch 150 can schedule and distribute received queries (e.g., related to dataset 301, or the like) to nodes 142 in the compute cluster 310 based on metrics 170. More specifically, during operation, the load balancing switch 150 can receive metrics (e.g., resource utilization, or the like) from the nodes 142-1, 142-2, and/or 142-3 and can determine network metrics (e.g., latency, throughput, or the like) related to the system 300. The load balancing switch can determine which nodes in the compute cluster to schedule and distribute queries based on the metrics. In some examples, the load balancing switch 150 can include circuitry 152 and other elements depicted in FIG. 2.

The transaction broker 330 can be implemented on a node of the system 300. In general, the transaction broker 330 can be implemented to hold the shared state needed to process transactions (e.g., queries, or the like). For example, the transaction broker 330 can maintain information elements 332 including indications of transaction metadata, versioned write-sets (e.g., for concurrency control), and/or a transaction sequencer. The transaction broker 330 may be implemented such that the system 300 can be operated with a minimum of shared states between nodes in the compute cluster 310.

The storage cluster 320 can be implemented on a node or nodes of the system 300. For example, as depicted, the storage cluster 320 includes nodes 142-4, 142-5, and 142-6. In general, the storage cluster 320 can maintain objects related to query processing in computer-readable storage, can process writes for versions of the objects, and can serve read requests those objects.

The compute cluster 310 can be implemented using any of a number of nodes in the system 300. For example, as depicted, the compute cluster 310 includes nodes 142-1, 142-2, and 142-3. Furthermore, the compute cluster 310 can include a distributed query processor (DQP) 312. The DQP 312 can be implemented on a node (or nodes) of the system 300. In general, the DQP 312 can be implemented to facilitate the load balancing switch in distributing queries. For example, the DQP 312 can parse queries, apply semantic analysis on the queries, compile the queries into executable instructions, and/or optimize the queries. However, as described herein, the load balancing switch 150 can schedule queries on the nodes in the compute cluster 310 based on both resources (e.g., resource metrics 172) and the network (e.g., network metrics 174).

Turning more particularly to FIG. 4 and the query processing system 400. The system 400 can include a compute cluster 410, a storage cluster 420, a transaction broker 430, and a number of load balancing switches 150. In particular, the system 400 is depicted including load balancing switches 150-1, 150-2, and 150-3. In general, each of the load balancing switches 150 can be configured to optimize routing (e.g., query distribution, or the like) for particular aspects of the operation of the system 400. This is described in greater detail below.

The compute cluster 410 can include compute nodes, for example, nodes 142 configured to execute queries while the storage cluster 420 can include storage nodes, for example, nodes 142 configured to store data. In particular, the compute cluster 410 is depicted including compute nodes 142-1, 142-2, and 142-3 while the storage cluster 420 is depicted including storage nodes 142-4, 142-5, and 142-6. It is noted, the depicted nodes 142 can comprise any number or arrangement of elements, such as, elements depicted in FIG. 1. For example, compute nodes 142-1, 142-2 and 142-3 can include CPU 112 and memory 114 elements while storage nodes 142-4, 142-5, and 142-6 can include at least storage elements 116. Examples are not limited in this context.

In general, the load balancing switches 150 can schedule and distribute received queries (e.g., related to dataset 401, or the like) to nodes 142 in the compute cluster 410 based on metrics 170. More particularly, during operation, the load balancing switch 150-1 can receive metrics (e.g., resource utilization, or the like) from transaction broker 430 and can determine network metrics (e.g., latency, throughput, or the like) related to the system 400. The load balancing switch 150-1 can optimize multiple user query requests, or optimize execution of queries related to multiple user, multiple datasets, or the like based on the metrics. In some examples, the load balancing switch 150-1 can include circuitry 152 and other elements depicted in FIG. 2.

The load balancing switch 150-2 can receive metrics (e.g., resource utilization, or the like) from the nodes 142-1, 142-2, and/or 142-3 and can determine network metrics (e.g., latency, throughput, or the like) related to the system 400. The load balancing switch 150-2 can determine which nodes in the compute cluster 410 to schedule and distribute queries based on the metrics. In some examples, the load balancing switch 150-2 can include circuitry 152 and other elements depicted in FIG. 2.

The load balancing switch 150-3 optimize and distribute read and/or write requests from the storage cluster 420. For example, during operation, the load balancing switch 150-3 can receive metrics (e.g., disk load, or the like) from the nodes 142-4, 142-5, and/or 142-6 and can determine network metrics (e.g., latency, throughput, or the like) related to the system 400. The load balancing switch 150-3 can determine which nodes in the storage cluster 420 to schedule and distribute read and/or write requests to, based on the metrics. In some examples, the load balancing switch 150-3 can include circuitry 152 and other elements depicted in FIG. 2.

The transaction broker 430 can be implemented on a node of the system 400. In general, the transaction broker 430 can be implemented to hold the shared state needed to process transactions (e.g., queries, or the like). For example, the transaction broker 430 can maintain information elements 432 including indications of transaction metadata, versioned write-sets (e.g., for concurrency control), and/or a transaction sequencer. The transaction broker 430 may be implemented such that the system 400 can be operated with a minimum of shared states between nodes in the compute cluster 410.

The storage cluster 420 can be implemented to on a node or nodes of the system 400. For example, as depicted, the storage cluster 420 includes nodes 142-4, 142-5, and 142-6. In general, the storage cluster 420 can maintain objects related to query processing in computer-readable storage, can process writes for versions of the objects, and can serve read requests those objects.

The compute cluster 410 can be implemented using any of a number of nodes in the system 400. For example, as depicted, the compute cluster 410 includes nodes 142-1, 142-2, and 142-3. Furthermore, the compute cluster 410 can include a distributed query processor (DQP) 412. The DQP 412 can be implemented on a node (or nodes) of the system 400. In general, the DQP 412 can be implemented to facilitate the load balancing switch in distributing queries. For example, the DQP 412 can parse queries, apply semantic analysis on the queries, compile the queries into executable instructions, and/or optimize the queries. However, as described herein, the load balancing switch 150 can schedule queries on the nodes in the compute cluster 410 based on both resources (e.g., resource metrics 172) and the network (e.g., network metrics 174).

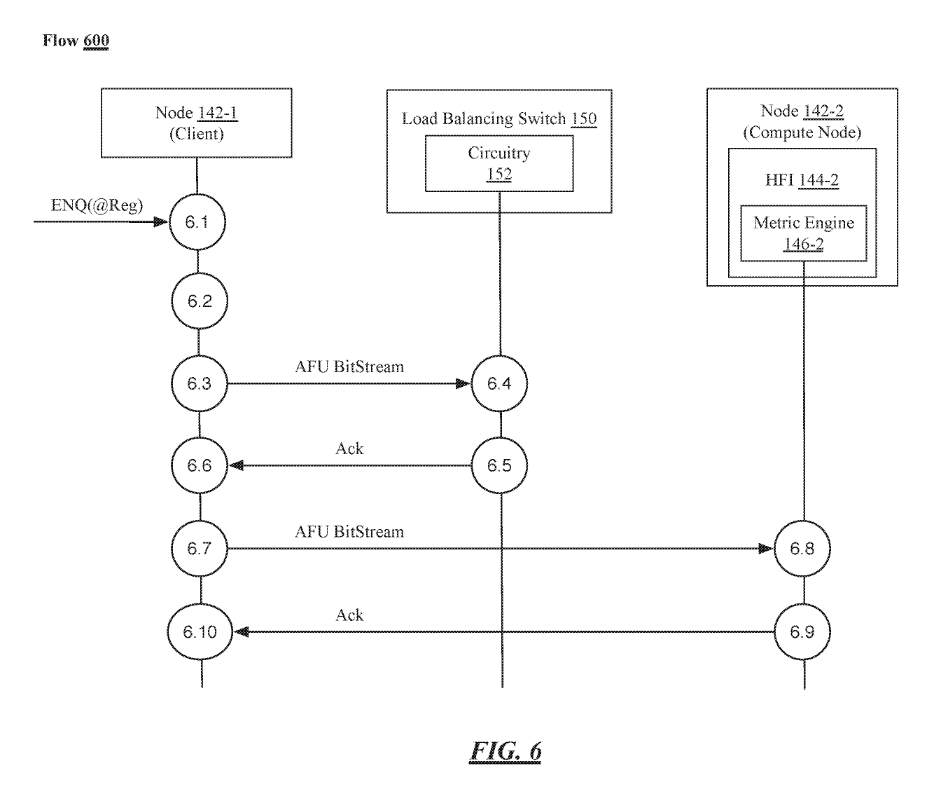

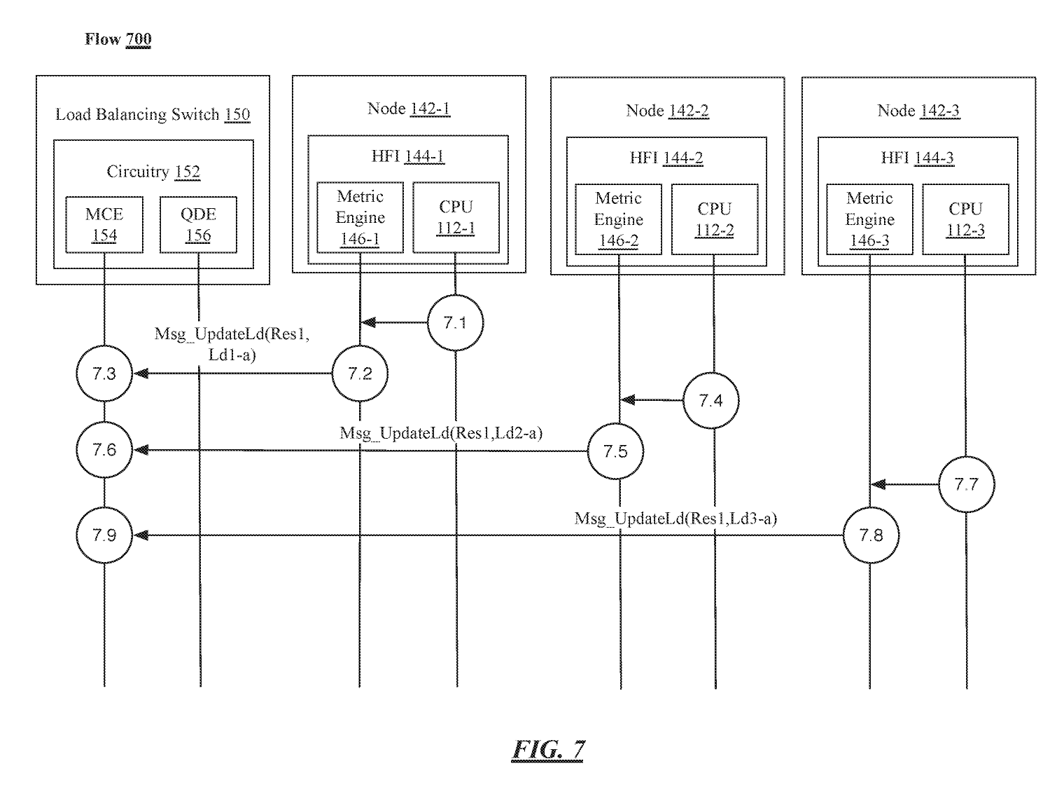

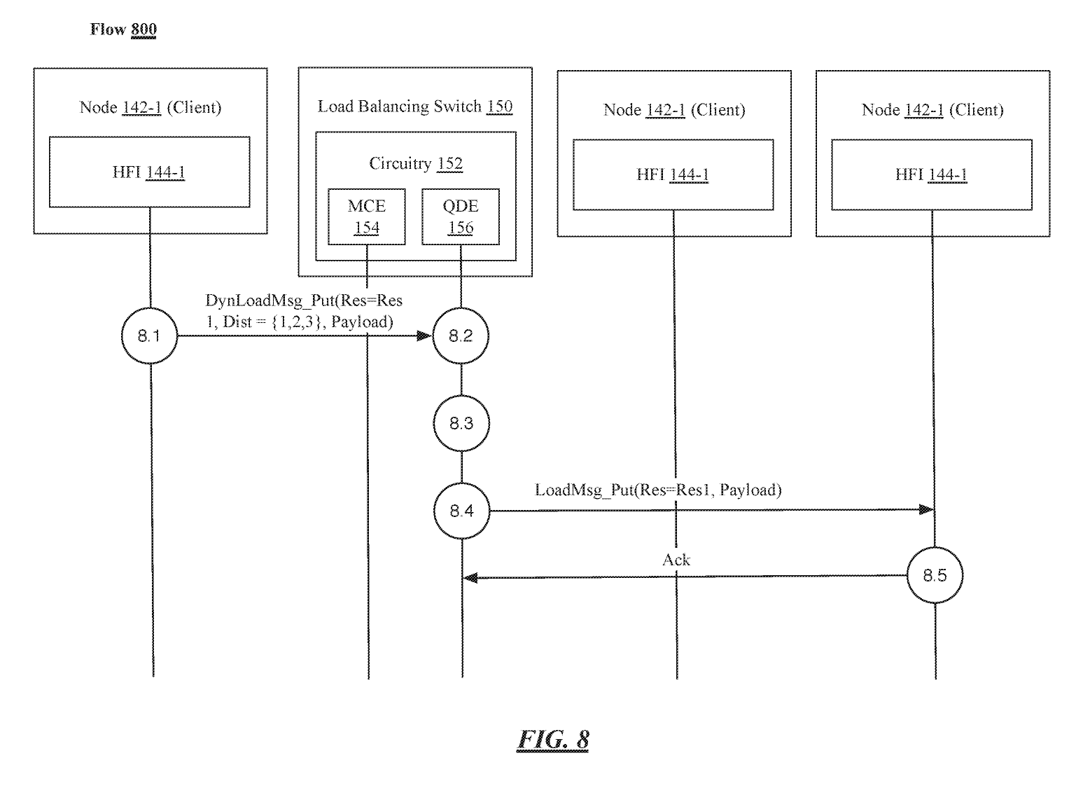

FIGS. 5-8 depict example techniques, or messages flows, to schedule and distribute queries as described herein. In particular, FIG. 5 depicts an example information element 500 that can be communicated by a node to a load balancing switch to register the node and provide an indication of node metrics. FIG. 6 depicts an example configuration flow 600 for a load balancing switch and a local node. FIG. 7 depicts an example registration flow 700 for multiple nodes of a system and FIG. 8 depicts an example load balancing flow 800 for multiple nodes of a system. It is noted, that the information element and the flows 600, 700, and 800 are described with reference to the system 200 depicted in FIG. 2. However, the message and flows could be implemented in a system, such as, for example, the system 300, the system 400, or another system having alternative arrangements and/or nodes than depicted herein.

Turning more particularly to FIG. 5, the information element 500 is depicted. In some examples, the information element 500 can be referred to as a message, or msg. In some examples, the information element 500 can be generated by the nodes and sent to the load balancing switch in a system as described herein to indicate resource utilizing of the nodes. For example, the HFI 144-1 can generate the information element 500 and send the information element 500 to the load balancing switch 150 via virtual channel 161. In general, the information element 500 can include an indication of the node sending the message and an indication of at least one metric. Additionally, the information element can include an indication of a query the node is currently processing, a time stamp, or the like. For example, information element 500 is depicted including a unique identification field 510, a metric field 520, and time stamp field 530. It is noted, the fields are depicted contiguously located within the information element 500. However, the fields could not be contiguous. Furthermore, only a single metric field 520 is depicted. However, the information element 500 could include multiple metric fields 520, or the metric field 520 could indicate values for multiple metrics. Examples are not limited in this context.

Turning more particularly to FIG. 6, system 200 is depicted including node 142-1 and load balancing switch 150. As described herein, the node 142-1 could correspond to a client node of the system 200. For example, a client terminal, a VM accessed by the client, or the like. Flow 600 can begin at block 6.1. At block 6.1 the node 142-1 can receive an enquiry to register a new set of queries and/or to execute new queries on a dataset. For example, the node 142-1 can receive the enquiry from a query application on the node 142-1. Continuing to block 6.2, the node 142-1 can extract parameters from the enquiry. For example, node 142-1 can determine metrics to be collected and/or communicate from the local nodes 142 to the load balancing switch 150. Additionally, node 142-1 can determine a frequency of metric collection and/or reporting. Additionally, the node 142-1 can determine a query distribution, or load balancing algorithm to be implemented by the switch 150.

Continuing to block 6.3 the node 142-1 can send a control signal to the load balancing switch 150 to configure the load balancing switch to distribute queries based on metrics as described herein. For example, the node 142-1 can send a bit stream to the circuitry 152 to configure the metric collection engine 154 and the query distribution engine 156. Continuing to block 6.4 the load balancing switch 150 can receive a control signal to include an indication of configuration parameters for the load balancing switch 150. For example, the circuitry 152 can receive a bit stream to configure one or more MSRs within the circuitry 152. For example, the circuitry 152 can receive a bit stream including one or more bit sequences to configure registers within the circuitry 152. A table including example MSRs and corresponding resource types is given in the following Table. It is noted, that the table is given for example only and not to be limiting.

TABLE 1
Resource ID system mapping

| MSR | VirtualResourceID | Metric Type | Desc |
|---|---|---|---|
| RES_ID_1 | 0x001 | HW | DRAM_Memory |
| RES_ID_2 | 0x002 | HW | CPU |
| RES_ID_3 | 0x003 | HW | Disk_SATA |
| RES_ID_4 | 0x004 | HW | Disk_SXP |
| RES_ID_5 | 0x005 | SW | DB_LD |
| RES_ID_6 | 0x006 | SW | Server_LD |

Continuing to block 6.5 the load balancing switch 150 can configure the circuitry 150 based on the received control signal(s) and can send an acknowledgment to the node 142-1. Continuing to block 6.6 the node 142-1 can receive the acknowledgment.

Continuing to block 6.7 the node 142-1 can send a control signal to a local node 142 to configure the local node to collect and report metrics to the load balancing switch as described herein. For example, the node 142-1 can send a bit stream to the metric engine 146-2 of HFI 144-2 of local node 142-2. Continuing to block 6.8 the metric engine 146-2 can receive a control signal to include an indication of configuration parameters for the metric engine. For example, the circuitry metric engine 146-2 can receive a bit stream to configure one or more MSRs within the circuitry metric engine 146-2. Continuing to block 6.9 the HFI 144-2 can configure the metric engine 146-2 based on the received control signal(s) and can send an acknowledgment to the node 142-1. Continuing to block 6.10 the node 142-1 can receive the acknowledgment.

Turning more particularly to FIG. 7 and the flow 700. In general, the flow 700 depicts local nodes collecting and reporting metrics to the load balancing switch 150. In particular, the flow 700 depicts local 142-1, 142-2, and 142-3 collecting a CPU utilization metric and reporting the metric to the load balancing switch 150. It is noted, that the flow 700 can proceed in any order and/or be repeated a number of times to collect and report multiple metrics and/or multiple instances of the same metric. Examples are not limited in this context.

The flow 700 can begin at block 7.1. At block 7.1, metric engine 146-1 of HFI 144-1 can determine CPU utilization rate from CPU 112-1 associated with node 142-1. Continuing to block 7.2, the metric engine 146-1 of HFI 144-1 can report the collected CPU utilization rate to load balancing switch 150. In particular, the metric engine 146-1 can send an information element (e.g., the information element 500, or the like) including an indication of the utilization rate to the metric collection engine 154 of circuitry 152. As a specific example, the metric engine 146-1 can send a Msg_Update command. For example, the metric engine 146-1 can send Msg_Update(Res=Res1, Load, Ld1-a) where the Res can correspond to the resource to use to distribute or load balance queries and Load can be the metric value (e.g., CPU load, or the like) for the particular instance in which the metric is being reported.

Continuing to block 7.3, the metric collection engine 154 can receive an information element including an indication of the CPU utilization of the node 142-1 and can add the metric to the resource metrics 172 of the metrics 170.

Continuing to block 7.4, metric engine 146-2 of HFI 144-2 can determine CPU utilization rate from CPU 112-2 associated with node 142-2. Continuing to block 7.5, the metric engine 146-2 of HFI 144-2 can report the collected CPU utilization rate to load balancing switch 150. In particular, the metric engine 146-2 can send an information element (e.g., the information element 500, or the like) including an indication of the utilization rate to the metric collection engine 154 of circuitry 152. As a specific example, the metric engine 146-2 can send a Msg_Update command. For example, the metric engine 146-2 can send Msg_Update(Res=Res1, Load=Ld1-a) where the Res can correspond to the resource to use to distribute or load balance queries and Load can be the metric value (e.g., CPU load, or the like) for the particular instance in which the metric is being reported.

Continuing to block 7.6, the metric collection engine 154 can receive an information element including an indication of the CPU utilization of the node 142-2 and can add the metric to the resource metrics 172 of the metrics 170.

Continuing to block 7.7, metric engine 146-3 of HFI 144-3 can determine CPU utilization rate from CPU 112-3 associated with node 142-3. Continuing to block 7.8, the metric engine 146-3 of HFI 144-3 can report the collected CPU utilization rate to load balancing switch 150. In particular, the metric engine 146-3 can send an information element (e.g., the information element 500, or the like) including an indication of the utilization rate to the metric collection engine 154 of circuitry 152. As a specific example, the metric engine 146-3 can send a Msg_Update command. For example, the metric engine 146-3 can send Msg_Update(Res=Res1, Load=Ld1-a) where the Res can correspond to the resource to use to distribute or load balance queries and Load can be the metric value (e.g., CPU load, or the like) for the particular instance in which the metric is being reported.

Continuing to block 7.9, the metric collection engine 154 can receive an information element including an indication of the CPU utilization of the node 142-3 and can add the metric to the resource metrics 172 of the metrics 170.

As noted, the flow 700 can be repeated a number of times to repeatedly (e.g., on a fixed period, upon trigger from the load balancing switch, or the like) collect metrics from nodes in the system. It is noted, that the collected resource could be any number of resources and the CPU utilization is given for an example only. In particular, the metric can be memory usage, disk load, cache usage, GPU utilization, or the like.

In some examples, the metrics reported in flow 700 (e.g., at block 7.2, block 7.5, block 7.8, or the like) can be sent using datagram messages, which can be non-reliable. However, given that the messages are sent periodically by the nodes, acknowledgment and 100% reliability is not necessary. As such, bandwidth channels can be saved.

In some examples, the HFI (e.g., HFI 144, or the like) can include an exposed command (e.g., a command including an indication of a memory pointer and one or more parameters, or the like), which when asserted indicates a change of the metric and need to report the changed metric to the load balancing switch 150.

In general, the frequency in which the flow 700 is repeated can depend on a variety of factors. In some examples, applications executing on the node may determine (e.g., by assertion of the command including an indication of a memory pointer and one or more parameters, or the like) a rate of metric collection and reporting. In some examples, the metric engine 146 of the HFI 144 can determine the rate of metric collection, for example, a lower rate of collection and reporting can be determined for resource utilization below a threshold level (e.g., below 20%, below 30%, below 40%, below 50%, or the like).

Turning more particularly to FIG. 8 and the flow 800. In general, the flow 800 depicts the load balancing switch 150 receiving and distributing a query request to local nodes. In particular, the flow 800 depicts the load balancing switch receiving a first and a second query request and distributing the query requests to ones of the local nodes 142-1, 142-2, and 142-3. It is noted, that the flow 800 can be implemented to receive and distribute any number of query requests. Examples are not limited in this context.

The flow 800 can begin at block 8.1. At block 8.1, the load balancing switch 150 can receive a query request. For example, the query distributor 156 of the circuitry 152 can receive a command including an indication to process a query. As a specific example, the query distributor 156 can receive a DynLoadMsg_Put command. For example, the query distributor engine 156 can receive DynLoadMsg_Put(Res=Res1, Dist={1, 2, 3}, Payload) where the Res can correspond to the resource to use to distribute or load balance queries, Dist can correspond to the nodes queries can be distributed to, and Payload can be the query payload, or the like.

Continuing to block 8.2, the query distributor engine 156 can receive a query request (e.g., from a user, from a node, from the client node, or the like). For example, the query distribution engine 156 can receive a DynLoadMsg_Put command. Continuing to block 8.3, the query distributor can select one of the nodes to distribute the query, for example, based on metrics 170 as described herein. It is important to note, that the query distributor can select a node to schedule and/or distribute the query to, based on resource metrics 172 and network metrics 174.

Continuing to block 8.4 the query distributor 156 can distribute the query to the selected node. As depicted in this example, the selected node is the node 142-1. In some examples, the query distributor 156 of the circuitry 152 can send a command including an indication to process a query to the selected node. As a specific example, the query distributor 156 can send a LoadMsg_Put command to the selected node. For example, the query distributor 156 can send LoadMsg_Put(Res=Res1, Payload) to the node 142-1. Continuing to block 8.5, the node 142-1 can receive the query and respond with an acknowledgment.

It is noted, that the flow 800 can be repeated for any number of queries. Furthermore, the flows 700 and 800 can be implemented in conjunction with each other such that metrics are periodically collected and queries distributed based on the periodically collect metrics.

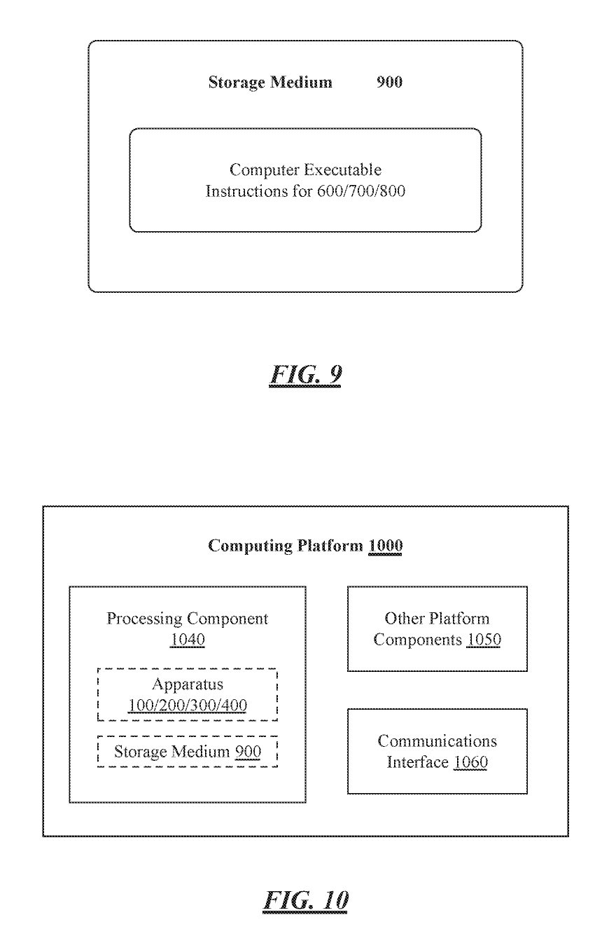

FIG. 9 illustrates an example storage medium 900. As shown in FIG. 9, the storage medium includes a storage medium 900. The storage medium 900 may comprise an article of manufacture. In some examples, storage medium 900 may include any non-transitory computer readable medium or machine readable medium, such as an optical, magnetic or semiconductor storage. Storage medium 900 may store various types of computer executable instructions, such as instructions to implement flow 600, flow 700, and/or flow 800. Examples of a computer readable or machine readable storage medium may include any tangible media capable of storing electronic data, including volatile memory or non-volatile memory, removable or non-removable memory, erasable or non-erasable memory, writeable or re-writeable memory, and so forth. Examples of computer executable instructions may include any suitable type of code, such as source code, compiled code, interpreted code, executable code, static code, dynamic code, object-oriented code, visual code, and the like. The examples are not limited in this context.

FIG. 10 illustrates an example computing platform 1000. In some examples, as shown in FIG. 10, computing platform 1000 may include a processing component 1040, other platform components 1050 or a communications interface 1060. According to some examples, computing platform 1000 may host management elements (e.g., cloud infrastructure orchestrator, network data center service chain orchestrator, or the like) providing management functionality for a query processing system having a collection of nodes, such as system 100 of FIG. 1, system 200 of FIG. 2, system 300 of FIG. 3, or system 400 of FIG. 4. Computing platform 1000 may either be a single physical server or a composed logical server that includes combinations of disaggregate components or elements composed from a shared pool of configurable computing resources.

According to some examples, processing component 1040 may execute processing operations or logic for apparatus 100, 200, 300, 500 and/or storage medium 900. Processing component 1040 may include various hardware elements, software elements, or a combination of both. Examples of hardware elements may include devices, logic devices, components, processors, microprocessors, circuits, processor circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, device drivers, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given example.

In some examples, other platform components 1050 may include common computing elements, such as one or more processors, multi-core processors, co-processors, memory units, chipsets, controllers, peripherals, interfaces, oscillators, timing devices, video cards, audio cards, multimedia input/output (I/O) components (e.g., digital displays), power supplies, and so forth. Examples of memory units may include without limitation various types of computer readable and machine readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory), solid state drives (SSD) and any other type of storage media suitable for storing information.

In some examples, communications interface 1060 may include logic and/or features to support a communication interface. For these examples, communications interface 1060 may include one or more communication interfaces that operate according to various communication protocols or standards to communicate over direct or network communication links. Direct communications may occur via use of communication protocols or standards described in one or more industry standards (including progenies and variants) such as those associated with the PCIe specification. Network communications may occur via use of communication protocols or standards such those described in one or more Ethernet standards promulgated by IEEE. For example, one such Ethernet standard may include IEEE 802.3. Network communication may also occur according to one or more OpenFlow specifications such as the OpenFlow Hardware Abstraction API Specification. Network communications may also occur according to the Infiniband Architecture specification or the TCP/IP protocol.

As mentioned above computing platform 1000 may be implemented in a single server or a logical server made up of composed disaggregate components or elements for a shared pool of configurable computing resources. Accordingly, functions and/or specific configurations of computing platform 1000 described herein, may be included or omitted in various embodiments of computing platform 1000, as suitably desired for a physical or logical server.

The components and features of computing platform 1000 may be implemented using any combination of discrete circuitry, application specific integrated circuits (ASICs), logic gates and/or single chip architectures. Further, the features of computing platform 1000 may be implemented using microcontrollers, programmable logic arrays and/or microprocessors or any combination of the foregoing where suitably appropriate. It is noted that hardware, firmware and/or software elements may be collectively or individually referred to herein as “logic” or “circuit.”

It should be appreciated that the exemplary computing platform 1000 shown in the block diagram of FIG. 10 may represent one functionally descriptive example of many potential implementations. Accordingly, division, omission or inclusion of block functions depicted in the accompanying figures does not infer that the hardware components, circuits, software and/or elements for implementing these functions would necessarily be divided, omitted, or included in embodiments.

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations, known as “IP cores” may be stored on a tangible, machine readable medium and supplied to various customers or manufacturing facilities to load into the fabrication machines that actually make the logic or processor.

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

Some examples may include an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner or syntax, for instructing a machine, computing device or system to perform a certain function. The instructions may be implemented using any suitable high-level, low-level, object-oriented, visual, compiled and/or interpreted programming language.

Some examples may be described using the expression “in one example” or “an example” along with their derivatives. These terms mean that a particular feature, structure, or characteristic described in connection with the example is included in at least one example. The appearances of the phrase “in one example” in various places in the specification are not necessarily all referring to the same example.

Some examples may be described using the expression “coupled” and “connected” along with their derivatives. These terms are not necessarily intended as synonyms for each other. For example, descriptions using the terms “connected” and/or “coupled” may indicate that two or more elements are in direct physical or electrical contact with each other. The term “coupled,” however, may also mean that two or more elements are not in direct contact with each other, but yet still co-operate or interact with each other.

The follow examples pertain to additional examples of technologies disclosed herein.

It is emphasized that the Abstract of the Disclosure is provided to comply with 37 C.F.R. Section 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single example for the purpose of streamlining the disclosure. This method of disclosure is not to be interpreted as reflecting an intention that the claimed examples require more features than are expressly recited in each claim. Rather, as the following claims reflect, inventive subject matter lies in less than all features of a single disclosed example. Thus the following claims are hereby incorporated into the Detailed Description, with each claim standing on its own as a separate example. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

The present disclosure can be implemented in any of a variety of embodiments, such as, for example, the following non-exhaustive listing of example embodiments.

### Example 1

An apparatus comprising: circuitry at a switch in a system comprising a plurality of nodes, the circuitry to: receive an indication of a first resource metric, the first resource metric corresponding to a first node of the plurality of nodes; receive an indication of a second resource metric, the second resource metric corresponding to a second node of the plurality of nodes; identify at least one network metric, the at least one network metric corresponding to a network parameter of the system; receive a query request; and distribute the query request to either the first node or the second node based on the first and second resource metric and the at least one network metric.

### Example 2

The apparatus of example 1, the circuitry comprising programmable logic.

### Example 3

The apparatus of example 2, wherein the programmable logic is a field programmable gate array (FPGA).

### Example 4

The apparatus of example 2, the circuitry programmable to distribute the query request based on distribution logic.

### Example 5

The apparatus of example 2, the circuitry to receive a control signal to include an indication of a type of the resource metric and the network metric.

### Example 6

The apparatus of example 5, the control signal comprising a bit stream.

### Example 7

The apparatus of example 1, the circuitry to receive an information element from the first node, the information element comprising an indication of the type of the first resource metric and an indication of a value of the first resource metric.

### Example 8

The apparatus of example 1, the circuitry to: receive an indication of an updated first resource metric; receive an indication of an updated second resource metric; and identify at least one updated network metric.

### Example 9

The apparatus of example 8, the circuitry to receive an additional query request and to distribute the additional query request to either the first node or the second node based on the updated first and second resource metrics and the at least one updated network metric.

### Example 10

The apparatus of any one of examples 1 to 9, wherein the resource metric comprises at least one of a processor utilization or a memory utilization.

### Example 11

The apparatus of any one of examples 1 to 9, wherein the at least one network metric comprises a network latency, a network bandwidth, or a network throughput.

### Example 12

An apparatus comprising: circuitry, at a node in a system comprising a plurality of nodes, the circuitry to: determine a resource metric corresponding to the circuitry; send an indication of the resource metric to a load balancing switch in the system, the load balancing switch to distribute query requests based on the resource metric and at least one network metric of the system.

### Example 13

The apparatus of example 12, the circuitry to receive a query request from the load balancing switch.

### Example 14

The apparatus of example 12, the circuitry comprising a host fabric interface to couple the node to the system.

### Example 15

The apparatus of example 12, the circuitry to send an information element to the load balancing switch to include an indication of a type of the resource metric and a value of the resource metric.

### Example 16

The apparatus of example 12, the circuitry to: determine an updated resource metric corresponding to the circuitry; and send an indication of the updated resource metric to the load balancing switch.

### Example 17

A method comprising: receiving, by circuitry at a switch in a system comprising a plurality of node, an indication of a first resource metric, the first resource metric corresponding to a first node of the plurality of nodes; receiving an indication of a second resource metric, the second resource metric corresponding to a second node of the plurality of nodes; identifying at least one network metric, the at least one network metric corresponding to a network parameter of the system; receiving a query request; and distributing the query request to either the first node or the second node based on the first and second resource metric and the at least one network metric.

### Example 18

The method of example 17, the circuitry comprising programmable logic.

### Example 19

The method of example 18, wherein the programmable logic is a field programmable gate array (FPGA).

### Example 20

The method of example 18, the circuitry programmable to distribute the query request based on distribution logic.

### Example 21

The method of example 18, comprising receiving a control signal to include an indication of a type of the resource metric and the network metric.

### Example 22

The method of example 21, the control signal comprising a bit stream.

### Example 23

The method of example 17, comprising receiving an information element from the first node, the information element comprising an indication of the type of the first resource metric and an indication of a value of the first resource metric.

### Example 24

The method of example 17, comprising: receiving an indication of an updated first resource metric; receiving an indication of an updated second resource metric; and identifying at least one updated network metric.

### Example 25

The method of example 24, comprising: receiving an additional query request; and distributing the additional query request to either the first node or the second node based on the updated first and second resource metrics and the at least one updated network metric.

### Example 26

The method of any one of examples 17 to 25, wherein the resource metric comprises at least one of a processor utilization or a memory utilization.

### Example 27

The method of any one of examples 17 to 25, wherein the at least one network metric comprises a network latency, a network bandwidth, or a network throughput.

### Example 28

At least one machine readable medium comprising a plurality of instructions that in response to being executed by system at a server cause the system to carry out a method according to any one of examples 17 to 27.

### Example 29

An apparatus comprising means for performing the methods of any one of examples 17 to 27.

### Example 30

A method comprising: determining, by circuitry of a node in a system of a plurality of nodes, a resource metric corresponding to the circuitry; and sending an indication of the resource metric to a load balancing switch in the system, the load balancing switch to distribute query requests based on the resource metric and at least one network metric of the system.

### Example 31

The method of example 30, comprising receiving a query request from the load balancing switch.

### Example 32

The method of example 30, the comprising a host fabric interface to couple the node to the system.

### Example 33

The method of example 30, comprising sending an information element to the load balancing switch to include an indication of a type of the resource metric and a value of the resource metric.

### Example 34

The method of example 30, comprising: determining an updated resource metric corresponding to the circuitry; and sending an indication of the updated resource metric to the load balancing switch.

### Example 35

An apparatus comprising means for performing the methods of any one of examples 30 to 34.

### Example 36

At least one machine readable medium comprising a plurality of instructions that in response to being executed by a switch in a system comprising a plurality of nodes cause the switch to: receive an indication of a first resource metric, the first resource metric corresponding to a first node of the plurality of nodes; receive an indication of a second resource metric, the second resource metric corresponding to a second node of the plurality of nodes; identify at least one network metric, the at least one network metric corresponding to a network parameter of the system; receive a query request; and distribute the query request to either the first node or the second node based on the first and second resource metric and the at least one network metric.

### Example 37

The at least one machine readable medium of example 36, the circuitry comprising programmable logic.

### Example 38

The at least one machine readable medium of example 37, wherein the programmable logic is a field programmable gate array (FPGA).

### Example 39

The at least one machine readable medium of example 37, the circuitry programmable to distribute the query request based on distribution logic.

### Example 40

The at least one machine readable medium of example 37, the instructions to further cause the switch to receive a control signal to include an indication of a type of the resource metric and the network metric.

### Example 41

The at least one machine readable medium of example 40, the control signal comprising a bit stream.

### Example 42

The at least one machine readable medium of example 36, the instructions to further cause the switch to receive an information element from the first node, the information element comprising an indication of the type of the first resource metric and an indication of a value of the first resource metric.

### Example 43

The at least one machine readable medium of example 36, the instructions to further cause the switch to: receive an indication of an updated first resource metric; receive an indication of an updated second resource metric; and identify at least one updated network metric.

### Example 44

The at least one machine readable medium of example 43, the instructions to further cause the switch to: receive an additional query request; and distribute the additional query request to either the first node or the second node based on the updated first and second resource metrics and the at least one updated network metric.

### Example 45

The at least one machine readable medium of any one of examples 36 to 44, wherein the resource metric comprises at least one of a processor utilization or a memory utilization.

### Example 46

The at least one machine readable medium of any one of examples 36 to 44, wherein the at least one network metric comprises a network latency, a network bandwidth, or a network throughput.

### Example 47

At least one machine readable medium comprising a plurality of instructions that in response to being executed by a host fabric interface (HFI) of a node in a system comprising a plurality of nodes cause the HFI to: determine a resource metric corresponding to the node; and send an indication of the resource metric to a load balancing switch in the system, the load balancing switch to distribute query requests based on the resource metric and at least one network metric of the system.

### Example 48

The at least one machine readable medium of example 47, the instructions to further cause the HFI to receive a query request from the load balancing switch.

### Example 49

The at least one machine readable medium of example 47, the instructions to further cause the HFI to send an information element to the load balancing switch to include an indication of a type of the resource metric and a value of the resource metric.

### Example 50

The at least one machine readable medium of example 47, the instructions to further cause the HFI to: determine an updated resource metric corresponding to the circuitry; and send an indication of the updated resource metric to the load balancing switch.

What is claimed is:

1. An apparatus comprising:
circuitry at a switch in a system comprising a plurality of nodes, the circuitry to:
receive an indication of a first resource metric, the first resource metric corresponding to a first node of the plurality of nodes;
receive an indication of a second resource metric, the second resource metric corresponding to a second node of the plurality of nodes;
identify at least one network metric, the at least one network metric corresponding to a network parameter of the system;
receive a query request; and
distribute the query request to either the first node or the second node based on the first and second resource metric and the at least one network metric.

2. The apparatus of claim 1, the circuitry comprising a field programmable gate array (FPGA).

3. The apparatus of claim 2, the FPGA programmable to distribute the query request based on distribution logic.

4. The apparatus of claim 1, the circuitry to receive a control signal to include an indication of a type of the resource metric and the network metric, the control signal comprising a bit stream.

5. The apparatus of claim 1, the circuitry to receive an information element from the first node, the information element comprising an indication of the type of the first resource metric and an indication of a value of the first resource metric.

6. The apparatus of claim 1, the circuitry to:
receive an indication of an updated first resource metric;
receive an indication of an updated second resource metric; and
identify at least one updated network metric.

7. The apparatus of claim 6, the circuitry to receive an additional query request and to distribute the additional query request to either the first node or the second node based on the updated first and second resource metrics and the at least one updated network metric

8. The apparatus of claim 1, wherein the resource metric comprises at least one of a processor utilization or a memory utilization.

9. The apparatus of claim 1, wherein the at least one network metric comprises a network latency, a network bandwidth, or a network throughput.

10. An apparatus comprising:
circuitry, at a node in a system comprising a plurality of nodes, the circuitry to:
determine a resource metric corresponding to the circuitry;
send an indication of the resource metric to a load balancing switch in the system, the load balancing switch to distribute query requests based on the resource metric and at least one network metric of the system.

11. The apparatus of claim 10, the circuitry to receive a query request from the load balancing switch.

12. The apparatus of claim 11, the circuitry comprising a host fabric interface to couple the node to the system.

13. The apparatus of claim 10, the circuitry to send an information element to the load balancing switch to include an indication of a type of the resource metric and a value of the resource metric.

14. The apparatus of claim 10, the circuitry to:
determine an updated resource metric corresponding to the circuitry; and
send an indication of the updated resource metric to the load balancing switch.

15. A method comprising:
receiving, by circuitry at a switch in a system comprising a plurality of node, an indication of a first resource metric, the first resource metric corresponding to a first node of the plurality of nodes;
receiving an indication of a second resource metric, the second resource metric corresponding to a second node of the plurality of nodes;
identifying at least one network metric, the at least one network metric corresponding to a network parameter of the system;
receiving a query request; and
distributing the query request to either the first node or the second node based on the first and second resource metric and the at least one network metric.

16. The method of claim 15, comprising receiving a control signal to include an indication of a type of the resource metric and the network metric, the control signal comprising a bit stream.

17. The method of claim 15, comprising receiving an information element from the first node, the information element comprising an indication of the type of the first resource metric and an indication of a value of the first resource metric.

18. The method of claim 15, comprising:
receiving an indication of an updated first resource metric;
receiving an indication of an updated second resource metric; and
identifying at least one updated network metric.

19. The method of claim 18, comprising:
receiving an additional query request; and
distributing the additional query request to either the first node or the second node based on the updated first and second resource metrics and the at least one updated network metric.

20. The method of claim 15, wherein the resource metric comprises at least one of a processor utilization or a memory utilization.

21. The method of claim 15, wherein the at least one network metric comprises a network latency, a network bandwidth, or a network throughput.

22. At least one machine readable medium comprising a plurality of instructions that in response to being executed by a host fabric interface (HFI) of a node in a system comprising a plurality of nodes cause the HFI to:
determine a resource metric corresponding to the node; and
send an indication of the resource metric to a load balancing switch in the system, the load balancing switch to distribute query requests based on the resource metric and at least one network metric of the system.

23. The at least one machine readable medium of claim 22, the instructions to further cause the HFI to receive a query request from the load balancing switch.

24. The at least one machine readable medium of claim 22, the instructions to further cause the HFI to send an information element to the load balancing switch to include an indication of a type of the resource metric and a value of the resource metric.

25. The at least one machine readable medium of claim 22, the instructions to further cause the HFI to:
determine an updated resource metric corresponding to the circuitry; and
send an indication of the updated resource metric to the load balancing switch.
